(19) United States
(12) Patent Application Publication
(10) Pub. No.: US 2003/0004901 A1
(43) Pub. Date: Jan. 2, 2003

(54) Method for a web portal providing personalized/customized electronic stamp advertisements

(75) Inventors: Rabindranath Dutta, Austin, TX (US); Dwip N. Banerjee, Austin, TX (US)

Correspondence Address: Frank C. Nicholas, CARDINAL LAW GROUP, Suite 2000, 1603 Ornngton Avenue, Evanston, IL, 60201, US

(73) Assignee: IBM CORPORATION

(21) Appl. No.: 09/896,023

(22) Filed: Jun. 29, 2001

(51) Int. Cl. G06F 17/60

(52) U.S. Cl. 705/402; 705/1; 705/14

(57) ABSTRACT

A system and a method for reducing postage cost to a customer are provided. A customer request input to subsidize postage is received. In response to the request a list of a plurality of third party advertisements is provided. A customer selection input corresponding to at least one of the third party advertisements is received. Subsidized postage and the selected third party advertisement are provided to the customer.

### BACKGROUND OF THE INVENTION

1. Field of the Invention

The present invention generally relates to a method for a web portal providing personalized/customized electronic stamp advertisements.

2. Description of the Related Art

Obtaining postage has often entailed such time consuming processes of purchasing stamps from a post office, transporting packages to the post office for metering or the leasing of expensive dedicated postage meters. This has often accounted for a considerable loss in productivity, as staff would have to travel to the post office to acquire postage by having the postal authorities directly meter mail, by purchasing of stamps, tokens or replenishing the postage meter. Although, there have been developments in this area which have permitted the replenishment of postage meters via telecommunication (see for example, U.S. Pat. Nos. 6,157,919 and 4,831,554), these remedies still require that the user be in the possession of a postage meter capable of receiving uploaded postage via telecommunication means. These means offer only a very limited capability to provide the customer the opportunity to feature customized or personalized postal indicia. Beyond this point, the customer is required to maintain a postal account for postage. It would be a significant advantage to have a means whereby postage could be made available to the customer anytime of day without traveling to the post office. Additional advantage would be realized by a system that could offer postage without requiring a postal account, postal meters or specialized systems.

Subsequent developments have sought to remedy some of these concerns by offering the customer computer readable programs that could reside on a personal computer, (see for example U.S. Pat. Nos. 5,319,562, 5,819,240, 5,717,597, 5,801,944 and 6,208,980). These methods provide for the use of replenishment of postage tokens either, in the form of hardware or firmware via modem or other telecommunication means. Again in each case the customer must incur the cost of software and establish a postal account. These methods are further restricted to platforms that are compatible with user's personal computer. Furthermore, these systems possess limited portability, insofar as the software must be resident upon a customer's computer subject to inherent licensing restrictions imposed by the software manufacturer. Although, there are provisions for the incorporation of customized/personalized postal indicia these are limited principally to those elements provided with the software license. Moreover, these particular systems do not allow low volume postal customers to enjoy postal subsidies for permitting third party advertisers to utilize the postal indicia as ad space. It would be desirable to have a portable system that would be overcome the requirements to establish postal accounts and would allow unrestricted access to third party advertiser postage subsidies.

The aspect of third party advertising postal subsidies has traditionally been limited to high volume postal patrons and often requires the use of highly specialized apparatus and systems as described in U.S. Pat. Nos. 6,178,411B1, 6,141,654 and 6,173,274B1. As the prospect of reaching a target market via postal advertising is extremely low, the incentive to offer subsidies has been reserved to large bulk mail patrons. Although, the aforementioned systems serve to provide an improved target market through the integration of demographics and advertising requirements, they lack the accuracy of direct customer response. Further, these systems require that both advertisers and bulk mailers maintain postage accounts on the mail system. These accounts are not necessarily real-time financial data and may result in either patrons missing an advertising opportunity due to inaccurate accounting data or a subsidy being offered when an account may be overdrawn. These systems frequently employ various commercial softwares to verify the address data provided by the bulk mailer to construct a demographic database that is presumed to be directed to the advertiser's target market in return for a subsidy. These methods lack the direct customer input that would yield a higher quality target market wholly independent of demographic models. It would be desirable to have a system that would provide third party advertising subsidies directly to individual and volume customers. It would also be desirable to have a system that would produce a more accurate target market listing to third party advertisers thereby allowing higher postal subsidies to be affected due to improved market targeting.

It would also be desirable to have a system that would allow the consumer to accurately post mail whereby the consumer could benefit from reduced cost from excess postage and avoid untimely mail delays due to insufficient postage. Such a system would also aid in reducing postal costs, as the handling of metered mail is a fraction of the cost of hand sorted mail. As the trend toward increased automation in mail handling continues the need to enhance efficiency and productivity are paramount to maintain postage costs and services.

It would be desirable to have a system, which overcomes the aforementioned disadvantages.

### SUMMARY OF THE INVENTION

The present invention relates to a method for a web portal providing subsidized personalized/customized electronic stamp advertisements. Various aspects of the invention are novel, non-obvious, and provide various advantages. While the actual nature of the present invention covered herein can only be determined with reference to the claims appended hereto, certain features, which are characteristic of the embodiments disclosed herein, are described briefly as follows.

One aspect of the invention provides a method for reducing postal costs to a customer. The customer request to subsidize postage is received. A list of a plurality of third party advertisements is provided in response to the request. A customer selection input corresponding to at least one of the third party advertisements is received. Subsidized postage and the selected third party advertisement output are provided to the customer. The cost of postage may be reduced based on a percentage of revenue received from the third party advertisement. Customer-supplied graphics may be received for incorporation into a postal indicia of the subsidized postage. Postal hygiene of customer-supplied graphics may be established prior to receiving the customer-supplied graphics. Payment verification of subsidized postage may be received from customer and third party postage subsidy. A secure postal transaction code may be assigned to the customer request. Information related to customer preferences may be stored in a database accessible by communication with an advertising node.

Another aspect of the invention provides for a computer usable medium storing a program for reducing postage costs to a customer. The program includes computer readable code to receive a customer request to subsidize postage, to provide a list of a plurality of advertisements in response to the request, to receive a customer selection input corresponding to at least one of the third party advertisements, to send customer identification and advertiser identification to the financial node and to provide subsidized postage and the selected third party advertisement to the customer.

Another aspect of the invention provides a system for reducing postage cost to a customer including a means to receive a customer request input to subsidize postage at a postal node, a means to send a list of a plurality of third party advertisements in response to the request input, a means to receive a customer selection input corresponding to at least one of the third party advertisements and a means to send the customer subsidized postage and third party advertisement.

Another aspect of the invention provides a method of operation of a web portal for reducing postage to a customer. The request to subsidize postage is received at a postal node from a customer node. The total postage cost is sent from the postal node to a financial node. Customer identification and advertiser identification is sent to the financial node. A request or payment of subsidized payment is sent from the financial node to the customer node. A computer readable code is sent which directs a plurality of third party advertisements to be sent to the customer node. A request for cost of an advertising subsidy is sent from the financial node to an advertiser node. Payment of a percentage of the total postage cost is received at the financial node from the advertiser node. Payment of a percentage of the total postage cost is received at the financial node from the customer node. Payment verification is sent to the postal node, customer node and advertiser node from the financial node. Subsidized postage and advertisement is sent to the customer node from the postal node.

### BRIEF DESCRIPTION OF THE DRAWINGS

FIG. 1 is a diagram of one embodiment of a system for a web portal for providing personalized/customized electronic stamp advertisements in accordance with the invention;

FIG. 2A and FIG. 2B is a flowchart of one embodiment illustrating a method of a web portal for providing personalized/customized electronic stamp advertisements in accordance with the invention; and

FIG. 3 is a flowchart of one embodiment of a routine for a computer readable program providing personalized/customizable electronic stamp advertisements in accordance with the invention.

### DETAILED DESCRIPTION OF THE PRESENTLY PREFERRED EMBODIMENTS

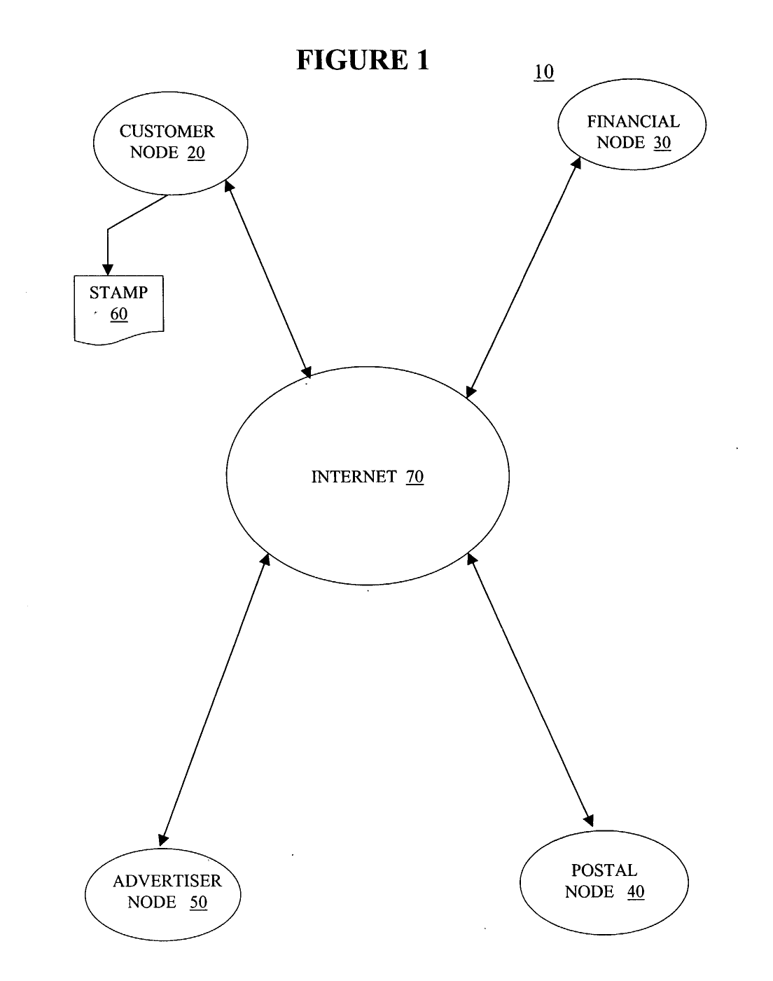

FIG. 1 illustrates one embodiment of a system for a web portal providing personalized/customized electronic stamp advertisements in accordance with the present invention.

Referring to FIG. 1 one embodiment of a web portal system providing personalized/customized electronic stamp advertisements is generally shown at number 10. The electronic stamp web portal system 10 may include a customer node 20, financial node 30, postal node 40, advertiser node 50 and Internet 70. The system 10 may receive a customer request to purchase postage via Internet 70 herein referred to as an electronic stamp 60 from the customer node 20. The customer node 20 may utilize any personal computer, personal digital assistant, digital telephone or any device capable of transmitting and receiving data over the Internet 70 known in the art and any means for printing the electronic transmission of postage, (electronic stamps) onto a medium acceptable to postal authorities. The customer node 20 may be operably connected to the Internet 70. The Internet 70 may route any number of digital signals to any of a plurality of server site addresses via various telecommunication means over the World Wide Web. Any commercially available Internet Service Provider (ISP), known in the art providing access to the World Wide Web, may access the Internet 70 for receiving and directing the customer request to buy postage to the postal node 40.

The postal node 40 may be any commercially available computer server capable of providing secure transactions over the Internet 70 via any hardware and/or software methods known in the art. The postal node 40 may receive a customer request for postage from the Internet 70. In one embodiment, the postal node 40 may convert the request for postage into a Postal Transaction Code (PTC) that may contain the customer identification data and total postage cost in addition to data packets that detail and facilitate the purchase of postage via the Internet 70. The postal node 40 may be operably connected to the Internet 70. The postal node 40 transmits a subsidized postage inquiry to the customer node 20 via the Internet 70, which asks the customer if they would accept third party advertisements on their electronic stamp 60 to offset the postage cost. The customer node 20 receives the subsidized postage inquiry from the postal node 40 via the Internet 70. The customer node 20 may either accept or decline the subsidized postage inquiry and may send a subsidized postage inquiry response to the postal node 40 via the Internet 70. The postal node 40 upon receiving a subsidized postage inquiry response from the customer node 20 via the Internet 70 evaluates the response. In reply to a positive response from the customer node 20 the postal node transmits the customer identification and PTC to the advertiser node 50 via the Internet 70. In one embodiment if the response is negative the postal node 40 transmits a total postage cost and PTC to the customer via the Internet 70.

The advertiser node 50 may be any commercially available computer server capable of providing secure transactions over the Internet 70 via any hardware and/or software methods known in the art. The advertiser node 50 may receive a customer subsidy inquiry reply for subsidized postage from the postal node 40 via the Internet 70. The advertiser node may be operably connected to the Internet 70. The advertiser node 50 the evaluates the reply using any commercially available demographic models or marketing tools known in the art to select from a bank of third party advertisers offering a subsidy to patrons in return for updated marketing data. In one embodiment the advertiser node 50 may convert non-secured portions of the PTC into market survey listings and statistics. The advertiser node 50 subsequent to surveying the reply generates a list of a plurality of advertisers to subsidize postage, which are transmitted to the customer node 20 via the Internet 70. The customer node 20 receives the list of advertisers willing to subsidize postage from the advertiser node 50 via the Internet 70. The customer node 20 may select one or more advertisers, based upon postal restrictions and transmits the selection to the advertiser node 50 via the Internet 70. In one embodiment the customer node 20 declines to participate with a third party advertiser and is redirected to the postal node 40 for payment of the total postage. In another embodiment the customer node 20 may select the option to produce customized or personalized postage using customer-supplied graphics facilitated through a third party for a fee. The customer node 20 subsequent to selecting an advertisement will then transmit payment of the subsidized postage and the PTC to the financial node 30 via the Internet 70. The advertiser node receives the selection from the customer node 20 via the Internet 70. The advertiser node 50 then transmits the PTC and a release for payment against the selected advertiser to the financial node 30 via the Internet 70.

The financial node 30 may be any commercially available computer server capable of providing secure financial transactions over the Internet 70 via any hardware and/or software methods known in the art. The financial node 30 may receive an electronic payment request from any of the advertiser node 50 or the customer node 20. The financial node 30 may be operably connected to the Internet 70. The financial node 30 may assemble the payment data using the PTC and other unique identifiers and methods known in the banking and the art of electronic financial transactions. The financial node 30 verifies the availability of funds from the advertiser node 50 and the customer node 20. Should the customer node 20 have insufficient funds to cover the cost of postage the financial node 30 will terminate the transaction and will not permit the transfer of funds from the advertiser node 50 accounts. Should the financial node 30 determine that the advertiser node 50 to have insufficient funds to subsidize the postage the decline is forwarded to the postal node 40 via the Internet 70. Subsequent to performing payment verification the financial node 30 transmits the verification data to the customer node 20, the advertiser node 50 and to the postal node 40 over the Internet 70.

The advertiser node 50 subsequent to receipt of the payment verification from the financial node 30 via the Internet 70 transmits the advertisement for inclusion in the postal indicia to the postal node 40 via Internet 70. In one embodiment the advertiser node 50 may insure that the advertisement satisfies postal hygiene requirements that mandate that no defamatory or offensive graphics or statements may be incorporated in the postal indicia, before releasing the advertisement to the postal node 40. The advertiser node 50 may assemble a database of customer preferences and utilize cookies or other similar software applications to collect and secure marketing data. The advertising node 50 may also create a unique customer identifier that would contain the customer's preferences that may be attached or embedded in the PTC during future transactions.

The postal node 40 may receive the advertisement from the advertiser node 50 via the Internet 70. The postal node 40 subsequent to receipt of the advertisement may verify its hygiene and may incorporate it into the postal indicia and may transmit the postage 60 to the customer node via the Internet 70.

The customer node 20 may receive payment verification from the financial node 30 via the Internet 70. This information may be processed separately or in conjunction with the postal indicia received from the postal node 40. The customer node 20 upon receipt of the postal indicia may transmit the postal indicia to any printer known in the art to print the postage, electronic stamp 60 either directly onto an envelope, package, label or any medium designated for such use by postal authorities. Subsequent to printing, the transaction may be terminated.

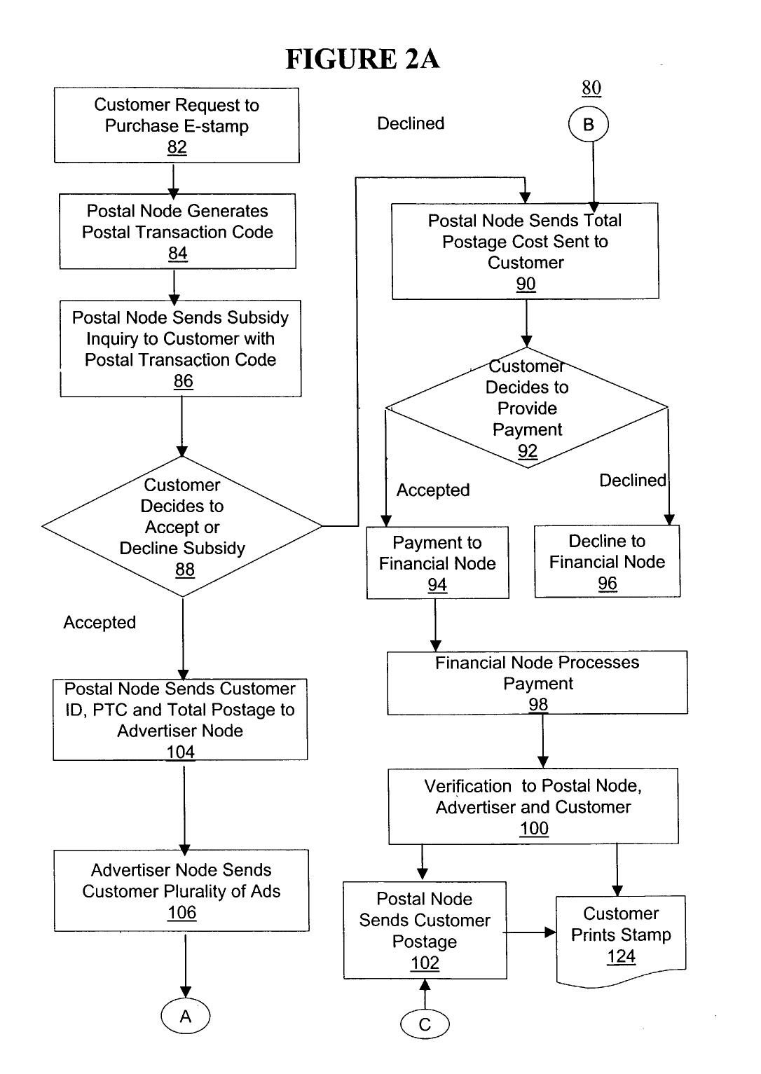

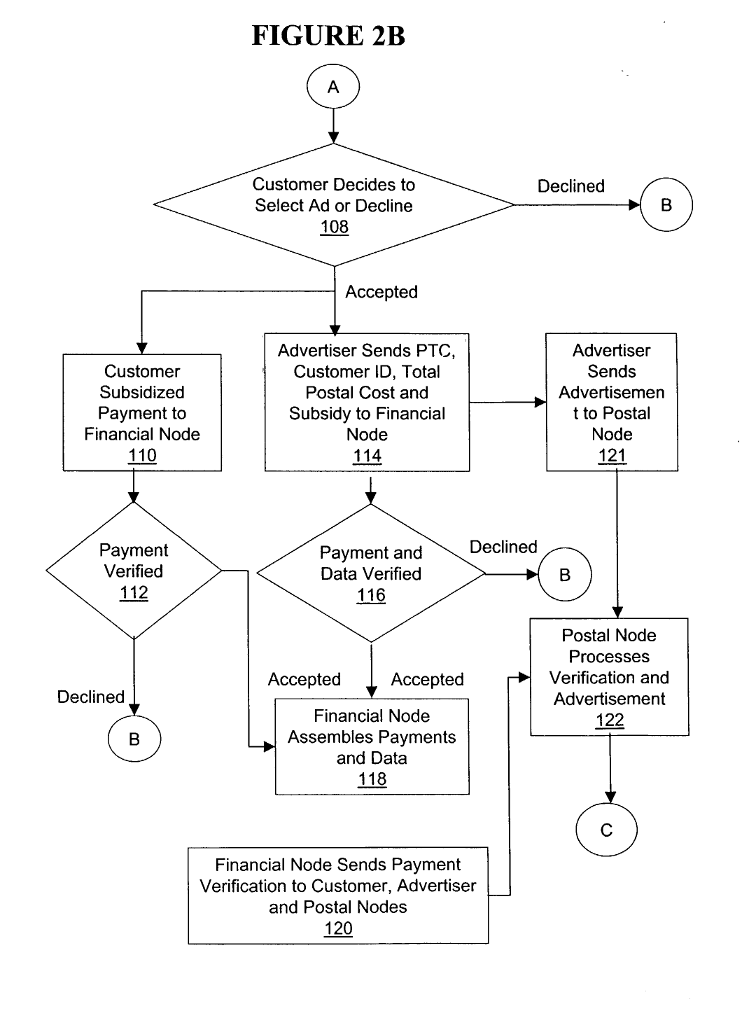

FIG. 2A and FIG. 2B illustrate one embodiment of a method for a web portal providing personalized/customized electronic stamp advertisements in accordance with the present invention.

Referring to FIG. 2A and FIG. 2B one embodiment of a method of a web portal for purchasing customizable/personalized electronic stamps is generally shown at 80. A customer requests to purchase an electronic stamp 60 where the customer node 20 transmits the request over the Internet 70 to the postal node 40 (Block 82). The postal node 40 upon receipt of the customer request may generate a Postal Transaction Code (PTC), which may include the customer identification, total postage cost and unique information to facilitate secure postal transactions (Block 84). The postal node 40 subsequent to the generation of the PTC will send the customer an inquiry for third party advertiser postage subsidy in addition to the PTC where the postal node 40 transmits the inquiry over the Internet 70 to the customer node 20 (Block 86). The customer may decide to accept or decline third party advertising to subsidize postal costs. Subsequently. the decision to accept or decline third party advertising to subsidize postal costs is communicated where the customer node 20 transmits the reply via the Internet 70 to the postal node 40 (Block 88).

Should the customer decline third party advertising subsidies the postal node 40 provides the total postage cost to the customer with the PTC, where the postal node 40 transmits the data to the customer node 20 via the Internet 70 (Block 90). The customer upon receiving the postage cost may decide to facilitate payment or cancel the transaction (Block 92). The customer may decide to facilitate payment by using any means of electronic payment as a financial institution designated to handle such transactions would accept where the customer node 20 transmits the payment data over the Internet 70 to the financial node 30 (Block 94). Alternatively, the customer may decide to cancel the transaction by transmitting cancellation to the financial institution, which subsequently confirms the cancellation where the customer node 20 transmits the cancellation data over the Internet 70 to the financial node 30 (Block 96). The financial institution subsequent to the receipt of the customer's payment or cancellation request, verifies and processes the data (Block 98). Subsequently, the financial node 30 provides transaction status to the postal institution, customer and third party advertiser where the financial node 30 transmits the payment status over the Internet 70 (Block 100). The postal node 40 subsequent to the receipt of payment verification sends the customer postage in the form of postal indicia where the postal node 40 transmits the postage to the customer node 20 over the Internet 70 (Block 102). The customer subsequent to receiving the postage and the payment verification may print the postage, (electronic stamp 60) where the customer node 20 receives postage and payment verification and sends a command to the printer (Block 124).

Should the customer decide to accept third party advertising subsidies the postal node 40 sends the customer identification, PTC and total postage cost to a third party advertiser where the postal node 40 transmits the data to an advertiser node 50 over the Internet 70 (Block 104). Subsequent to receipt of the customer identification, PTC and total postage cost the advertiser sends the customer a plurality of advertisements to select from where the advertiser node 50 transmits the a list of advertisements to the customer node 20 over the Internet 70 (Block 106). The customer subsequent to receiving the third party advertisements decides to select an advertisement or decline the subsidy where the customer node 20 transmits the decision to decline to the postal node 40 or accept the selected advertisement to the advertiser node 50 over the Internet 70 (Block 108). The postal node 40 subsequent to receipt of the decline processes the data at (Block 90) as described earlier. The customer subsequent to selecting an advertisement sends a subsidized payment to the financial node 30 where the customer node 20 transmits payment data to the financial node 30 via the Internet 70 (Block 110). The financial node 30 upon receiving the customer's subsidized postage payment verifies it and if payment is accepted it is held for further processing, if declined a notice is sent to the postal node 40 at (Block 90) over the Internet 70 (Block 112). The advertiser receives the customer's advertisement selection and sends the customer identification, PTC, total postage cost and postal subsidy to the financial node 30 where the advertiser node 50 transmits the data via the Internet 70 (Block 114). The financial node 30 upon receiving the advertiser's subsidized postage payment verifies it and if accepted it is held for further processing, if declined a notice is sent to the postal node 40 at (Block 90) over the Internet 70 (Block 116). The financial node 30 assembles the subsidy payment from the advertiser with the customer's payment and compares the total received with the total postage cost using the PTC, customer identification or any means for tracking and comparing the financial data (Block 118). The financial node 30 then sends payment verification to the customer, advertiser and postal node where the financial node 30 transmits the data over the Internet 70 (Block 120).

The advertiser sends the advertisement data to the postal node 40 for inclusion in the postal indicia where the advertiser node 50 sends the data over the Internet 70 (Block 121). The postal node 40 assembles the payment verification from the financial node 30 and the advertiser data and performs postal hygiene functions (Block 122). The postage is then transmitted in accordance to (Block 102) and printed by the customer as per (Block 124).

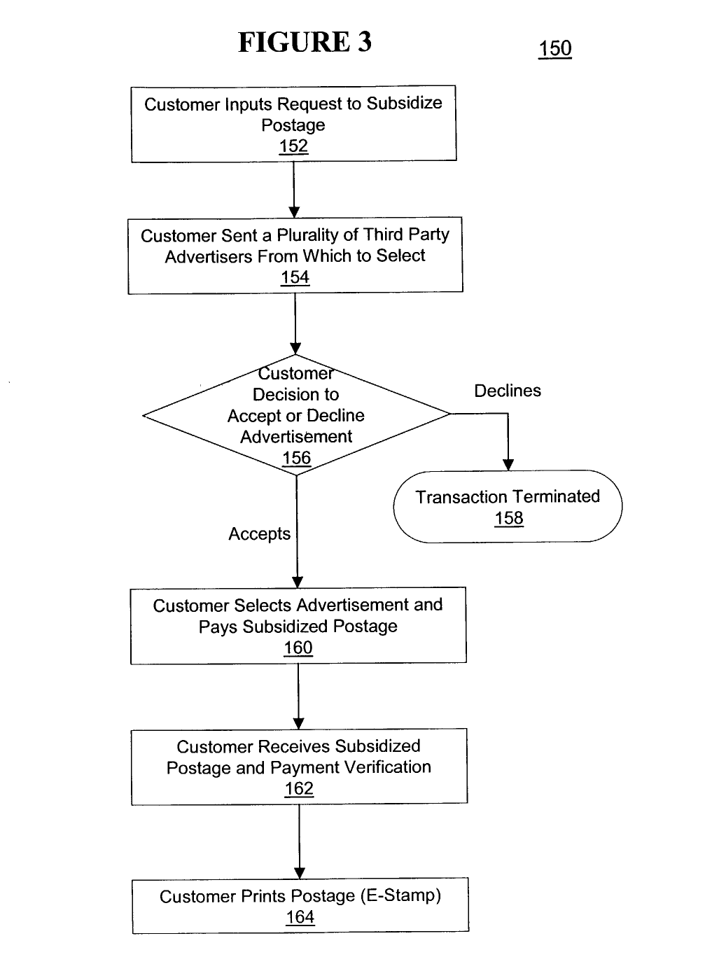

FIG. 3 illustrates one embodiment of a routine for a computer usable medium for a web portal providing personalized/customized electronic stamp advertisements in accordance with the present invention.

Referring to FIG. 3 one embodiment of a routine of a web portal for purchasing customizable/personalized electronic stamps is generally shown at 150. A customer request to subsidize postage through third party advertiser is input (Block 152). This request is communicated to various third party advertisers. The customer is then sent a list containing a plurality of available third party advertisements, which offer postage subsidies in return for their use (Block 154). A decision to decline or select one of the advertisements is made by the customer (Block 156). A decision to decline the offer terminates the transaction (Block 158). Subsequent to the customer 's selection of an advertisement the postage subsidy and subsidized postage are paid (Block 160). Verification of payment of the subsidized postage and postal indicia with advertisement are sent to customer (Block 162). Printing the received postage by the customer (Block 164).

In another embodiment the computer readable code may be distributed over the various nodes or centralized at one of the postal node 40, financial node 30, advertiser node 50 and customer node 20. The financial operations associated with the financial node 30 may be resident at any of the postal node 40, advertising node 50 or financial node 30. Likewise the advertising operations may be resident at one of the postal node 40, financial node 30 or advertising node 50. In another embodiment the computer readable code may reside on a third party server on the Internet 70 and be distributed among the postal node 40, advertiser node 50 and financial node 20 upon a selection from a customer node 20 requesting electronic stamps 60.

While the embodiments of the present invention disclosed herein are presently considered to be preferred, various changes and modifications may be made without departing from the spirit and scope of the present invention. The scope of the present invention is indicated in the appended claims, and all changes that come within the meaning and range of equivalents are intended to be embraced therein.

1. A method of reducing postage cost to a customer comprising:
receiving a customer request input to subsidize postage;
providing a list of a plurality of third party advertisements, in response to the request input;
receiving a customer selection input corresponding to at least one of the third party advertisements; and
providing subsidized postage and the selected third party advertisement to the customer.

2. The method of claim 1 further comprising reducing cost of postage based on a percentage of revenue received from the third party advertisement.

3. The method of claim 1 further comprising receiving customer-supplied graphics for incorporation into a postal indicia of the subsidized postage.

4. The method of claim 3 further comprising establishing postal hygiene of customer-supplied graphics prior to receiving the customer-supplied graphics.

5. The method of claim 1 further comprising receiving payment verification of subsidized postage from customer and third party postage subsidy.

6. The method of claim 1 further comprising assigning a secure postal transaction code to the customer request.

7. The method of claim 1 further comprising storing information related to customer preferences in a database accessible by communication with an advertising node.

8. A computer usable medium storing a program for reducing postage costs to a customer comprising:
a computer readable code for receiving a customer request to subsidize postage;
a computer readable code for providing a list of a plurality of third party advertisements, in response to the request;
a computer readable code for receiving a customer selection input corresponding to at least one of the third party advertisements; and
a computer readable code for providing subsidized postage and the selected third party advertisement to the customer.

9. The computer usable medium of claim 8 further comprising reducing cost of postage based on a percentage of revenue received from the third party advertisement.

10. The computer usable medium of claim 8 further comprising receiving customer-supplied graphics for incorporation into a postal indicia of the subsidized postage.

11. The computer usable medium of claim 10 further comprising establishing postal hygiene of customer-supplied graphics prior to receiving the customer-supplied graphics.

12. The computer usable medium of claim 8 further comprising receiving payment verification of subsidized postage from customer and third party postage subsidy.

13. The computer usable medium of claim 8 further comprising assigning a secure postal transaction code to the customer request.

14. The computer usable medium of claim 8 further comprising storing information related to customer preferences in a database accessible by communication with an advertising node.

15. A system for reducing postage cost to a customer comprising:
means for receiving a customer request input to subsidize postage at a postal node;
means for sending a list of a plurality of third party advertisements, in response to the request input;
means for receiving a customer selection input corresponding to at least one of the third party advertisements; and
means for sending subsidized postage and third party advertisement output to the customer.

16. The system of claim 15 further comprising means for reducing cost of postage based on a percentage of revenue received from the third party advertisement.

17. The system of claim 15 further comprising means for receiving customer-supplied graphics for incorporation into a postal indicia for a fee.

18. The system of claim 15 further comprising means for providing payment verification of subsidized postage and third party postage subsidy.

19. The system of claim 15 further comprising means for assigning a secure postal transaction code to the customer request.

20. The system of claim 15 further comprising means for storing information related to customer preferences in a database accessible by communication with an advertiser node.

21. A method of reducing cost of postage to a customer comprising;
receiving a request to subsidize postage at a postal node from a customer node from an advertiser node;
sending a total postage cost from the postal node to the financial node;
sending a computer readable code to send a plurality of advertisements to a customer node for selection;
sending customer identification and advertiser identification to the financial node;
sending a request for payment of subsidized postage from the financial node to the customer node;
sending request for cost of an advertising subsidy from the financial node to an advertiser node;
receiving a payment of a percentage of total postage cost at the financial node from the advertiser node;
receiving a payment of the percentage of total postage cost at the financial node from the customer node;
sending payment verification from the financial node to the postal node;
sending payment verification from the financial node to the advertiser node;
sending payment verification from the financial node to the customer node; and
sending subsidized postage and advertisement from the postal node to the customer.
